(19) United States
(12) Patent Application Publication
(10) Pub. No.: US 2026/0178006 A1
(43) Pub. Date: Jun. 25, 2026

(54) Method for Operating an Electric Drive System and Electric Drive System

(71) Applicant: LENZE SE, Aerzen (DE)

(72) Inventor: Torben JONSKY, Hannover (DE)

(21) Appl. No.: 18/713,230

(22) PCT Filed: Nov. 25, 2022
(86) PCT No.: PCT/EP2022/083308

§ 371 Date: May 24, 2024

(30) Foreign Application Priority Data
Nov. 26, 2021 (DE) 10 2021 213 375.4

(51) Int. Cl. G05B 19/404; B60W 10/08; G05B 19/05; G05B 19/19; G05B 19/4062

(52) U.S. Cl. CPC G05B 19/404; B60W 10/08; G05B 19/056; G05B 19/19; G05B 19/4062

(57) ABSTRACT

A method for operating an electric drive system having a first controlled system with a first controller includes the steps of: automatically parameterizing the first controller by: a) configuring the first controller as a two-position controller, b) specifying a target value for the first controller, c) measuring dynamic variables arising in the first controlled system, d) calculating controller parameters of a specified type of the first controller depending on the measured dynamic variables of the first controlled system, e) configuring the first controller to the specified type, and f) setting the calculated controller parameters.

### BACKGROUND AND SUMMARY

The invention is based on the object of providing a method for operating an electric drive system and an electric drive system that ensure the most robust possible operation of the electric drive system.

The method is used to operate an electric drive system, the electric drive system comprising a first controlled system containing a first controller.

According to the invention, the first controller can be automatically parameterized, the automatic parameterization of the first controller comprising the following steps: a) configuring the first controller as a conventional two-level controller, b) specifying a target value, c) measuring incipient dynamic variables of the first controlled system, d) calculating controller parameters of a specified type for the first controller on the basis of the measured dynamic variables of the first controlled system and optionally on the basis of data derived from the measurement, e) configuring the first controller for the specified type of the first controller, and f) setting the calculated controller parameters of the first controller.

In one embodiment, the first controlled system is a position controlled system and the first controller is a position controller, the dynamic variables of the position controlled system being a frequency and/or an amplitude of an incipient position oscillation of the position controlled system. Alternatively, the first controlled system is a rotational speed controlled system and the first controller is a rotational speed controller, the dynamic variables of the rotational speed controlled system being a frequency and/or an amplitude of an incipient rotational speed oscillation of the rotational speed controlled system. Alternatively, the first controlled system is a current controlled system and the first controller is a current controller, the dynamic variables of the current controlled system being a frequency and/or an amplitude of an incipient current oscillation of the current controlled system. A manipulated variable of the rotational speed controller may be a current or a corresponding torque, the automatic parameterization of the rotational speed controller being accomplished by limiting the current or the torque to a maximum current or a maximum torque.

In one embodiment, the electric drive system comprises a second controlled system containing a second controller, the second controlled system being connected downstream of the first controlled system. The method comprises the further steps of: automatically parameterizing the second controller by means of the steps of: configuring the second controller as a two-level controller, specifying a target value for the second controller, measuring incipient dynamic variables of the second controlled system, calculating controller parameters of a specified type for the second controller on the basis of the measured dynamic variables of the second controlled system, configuring the second controller for the specified type, and setting the calculated controller parameters. The second controlled system may be a rotational speed controlled system, for example, in which case the first controlled system is a position controlled system. Alternatively, the second controlled system may be a current controlled system, for example, in which case the first controlled system is a rotational speed controlled system. It goes without saying that in addition to the second controlled system there may also be further cascaded controlled systems. By way of example, a cascade (from out to in) of the following controlled systems is conceivable: position controlled system, rotational speed controlled system and current controlled system.

In one embodiment, the specified type of the first controller and/or the specified type of the second controller is a PID controller, the controller parameters of the respective PID controller being the controller gain, the controller adjustment time and the controller lead time.

In one embodiment, the controller parameters of the specified type of the first controller and/or of the specified type of the second controller are calculated according to Ziegler-Nichols and/or according to Chien, Hrones and Reswick.

In one embodiment, before step d) is carried out, steps a) to c) are repeated one or more times for an altered configuration of the two-level controller, the controller parameters subsequently being calculated in step d) on the basis of the dynamic variables of the rotational speed controlled system that result for the different configurations of the two-level controller.

The electric drive system is designed to carry out the method described above.

Preferably, the method is used to operate an electric drive system, the electric drive system comprising a conventional position controlled system containing a position controller, which together form a position control loop, and a conventional downstream rotational speed controlled system containing a rotational speed controller, which together form a rotational speed control loop. The rotational speed control loop may have a downstream current control loop containing a current controller and a current controlled system, the position controller, the rotational speed controller and/or the current controller being able to be automatically parameterized, according to the invention. With regard to the fundamental structure and properties of cascaded controlled systems such as these, reference will also be made to the relevant specialist literature.

The adjustment of the cascaded control of drive systems in the two cascades, position and rotational speed control and rotational speed and current control, is often carried out heuristically. These two controllers cannot be adjusted independently of one another, however, but rather are coupled. The present invention simplifies the parameterization of the two control loops by virtue of the cascaded control being controlled section by section for a short time by two-level control. An optimum controller setting is therefore automatically determined within the shortest time.

The invention is described in detail below with reference to the drawings.

### BRIEF DESCRIPTION OF THE DRAWINGS

FIG. 1 is a block diagram of a rotational speed control loop containing a conventional self-adjusting rotational speed controller; and

FIG. 2 is a highly schematic block diagram of an electric drive system, the electric drive system comprising a position control loop containing a position controlled system and a position controller and comprising a downstream rotational speed control loop containing a rotational speed controlled system and a rotational speed controller.

### DETAILED DESCRIPTION OF THE DRAWINGS

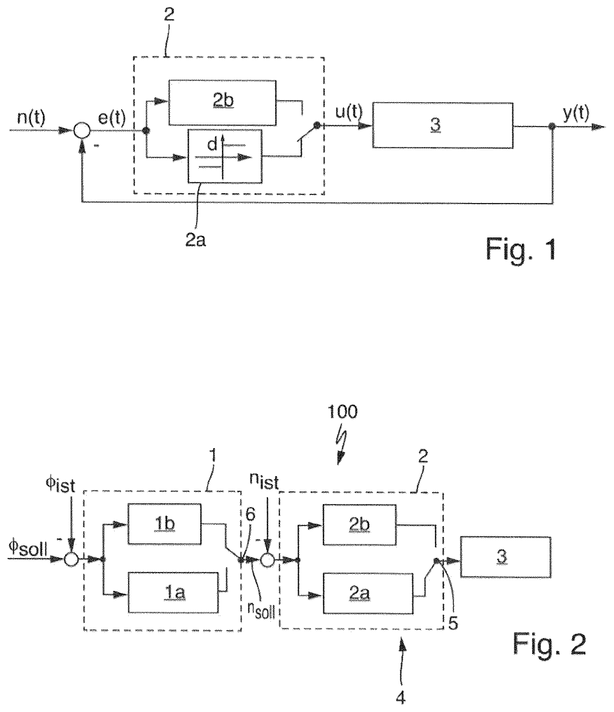

FIG. 1 shows a block diagram of a rotational speed control loop containing a self-adjusting rotational speed controller 2 and a rotational speed controlled system 3. The rotational speed controller 2 can be configured as a two-level controller 2a or as a PID controller 2b.

FIG. 2 shows highly schematically a block diagram of an electric drive system 100, the electric drive system 100 comprising a position control loop containing a position controlled system 4 and a position controller 1 and comprising a downstream rotational speed control loop containing a rotational speed controlled system 3 and a rotational speed controller 2; in this regard see also FIG. 1.

The automatic adjustment of the respective controller parameters of the controllers 1 and 2 of the electric drive system 100 shown in FIG. 2 takes place in two steps.

One of the two steps is the automatic parameterization of the rotational speed control loop, which is described below with reference to FIG. 2.

First, the PID rotational speed controller 2b provided for operation is replaced by the two-level rotational speed controller 2a. An arbitrary rotational speed target value and a maximum current or a maximum torque, which determines the amplitude of the two-level controller 2a, are then specified. The position controller 1 is deactivated in this step. For the manipulated variable u(t), see FIG. 1, a maximum modulation d of the target torque results in a square-wave oscillation having the period duration Tp. For the fundamental wave of the square-wave oscillation, the Fourier series then yields:

$${u}_{1} ( t ) = {\hat{u}}_{1} \cdot sin ( \frac{2 \cdot π}{{T}_{p}} \cdot t ) with {\hat{u}}_{1} = \frac{4 \cdot d}{π}$$

The low-pass response that can be assumed for the rotational speed controlled system 3, which is a series circuit comprising current control and a mechanical section in the case shown, results in a sinusoidal characteristic as the dynamic variable to be evaluated for the rotational speed controlled system y(t).

Let the amplitude of the dynamic variable to be evaluated for the rotational speed controlled system y(t) be ŷ. The critical controller gain K_{Krit} of the control loop is then obtained as:

$${K}_{Krit} = \frac{4 \cdot d}{\hat{y} \cdot π}$$

Using the adjustment rules according to Ziegler-Nichols or Chien, Hrones, Reswick, for example, the determined critical period duration of the control loop Tp results in stable parameterization of the rotational speed control loop. By way of example, Ziegler-Nichols can be used:

$${K}_{p , n} = 0.45 \cdot {K}_{Krit} and {T}_{n , n} = 0.85 \cdot {T}_{N}$$

The controller parameters of the position controller 1 are determined in a similar manner to the approach for the rotational speed controller 2. A prerequisite for this is that the controller parameters of the rotational speed controller 2b have already been determined. The position controlled system 4 is made up of the series circuit formed by the rotational speed controller 2, the current controller (not shown explicitly) and the mechanical section.

First, the automatic controller parameterization is accomplished by taking the switch 5 to the lower position and, as described above, specifying a rotational speed target value, in order to use the arising circumstances comprising a stimulus and a system output to determine the controller parameters of the rotational speed controller 2b.

Subsequently, the switch 5 is taken to the upper position and the switch 6 is taken to the lower position, in order to determine the controller parameters for the position controller 1b.

For operation, both switches 5, 6 are then in the upper position and the cascaded control is active. Only a few milliseconds in the respective two-level controller mode are required for each of the lower switch positions.

According to the invention, the amplitude of the two-level controllers 1a and 2a can be determined automatically. The amplitude must be neither so great that further limitations of the drive system take effect (voltage limits, current limits, and so on) nor too small, in order for an acceptable signal-to-noise ratio to be obtained.

Multiple measurements with different amplitudes in succession are also a possibility, in order to find optimum control even for pronounced nonlinearities. That is to say that multiple amplitudes would be used for measurement and a controller would be delivered each time and, for example, the one that is stable in every respect would be selected.

The invention allows the rotational speed controller 2b and the position controller 1b for simple controlled systems to be adjusted within a few milliseconds without knowledge of the system parameters, and the characteristic of the stability limit to be determined therefrom if necessary. Expert knowledge is not necessary for the adjustment. The same applies to the current controller, not shown explicitly, the controller parameters of which can be determined in the same manner.

1.-7. (canceled)

8. A method for operating an electric drive system having a first controlled system containing a first controller, the method comprising the steps of:
automatically parameterizing the first controller via the steps of:
a) configuring the first controller as a two-level controller,
b) specifying a target value for the first controller,
c) measuring incipient dynamic variables of the first controlled system,
d) calculating controller parameters of a specified type for the first controller based on the measured dynamic variables of the first controlled system,
e) configuring the first controller for the specified type, and
f) setting the calculated controller parameters.

9. The method according to claim 8, wherein
(i) the first controlled system is a position controlled system and the first controller is a position controller, wherein the dynamic variables of the position controlled system are a frequency and/or an amplitude of an incipient position oscillation of the position controlled system, or
(ii) the first controlled system is a rotational speed controlled system and the first controller is a rotational speed controller, wherein the dynamic variables of the rotational speed controlled system are a frequency and/or an amplitude of an incipient rotational speed oscillation of the rotational speed controlled system, or
(iii) the first controlled system is a current controlled system and the first controller is a current controller, wherein the dynamic variables of the current controlled system are a frequency and/or an amplitude of an incipient current oscillation of the current controlled system.

10. The method according to claim 8, wherein the electric drive system has a second controlled system containing a second controller, the second controlled system being connected downstream of the first controlled system,
the method further comprising the steps of:
automatically parameterizing the second controller via the steps of:
configuring the second controller as a two-level controller,
specifying a target value for the second controller,
measuring incipient dynamic variables of the second controlled system,
calculating controller parameters of a specified type for the second controller based on the measured dynamic variables of the second controlled system,
configuring the second controller for the specified type, and
setting the calculated controller parameters.

11. The method according to claim 10, wherein
the specified type of the first controller and/or the specified type of the second controller is a PID controller, and
the controller parameters of the PID controller are controller gain, controller adjustment time and controller lead time.

12. The method according to claim 10, wherein
the controller parameters of the specified type of the first controller and/or the specified type of the second controller are calculated according to Ziegler-Nichols and/or according to Chien, Hrones and Reswick.

13. The method according to claim 9, wherein
before step d) is carried out, steps a) to c) are repeated one or more times for an altered configuration of the two-level controller, the controller parameters subsequently being calculated in step d) based on the dynamic variables of the rotational speed controlled system resulting from the different configurations of the two-level controller.

14. A system, comprising:
an electric drive system having a first controlled system containing a first controller, wherein the electric drive system is configured to:
automatically parameterize the first controller by:
a) configuring the first controller as a two-level controller,
b) specifying a target value for the first controller,
c) measuring incipient dynamic variables of the first controlled system,
d) calculating controller parameters of a specified type for the first controller based on the measured dynamic variables of the first controlled system,
e) configuring the first controller for the specified type, and
f) setting the calculated controller parameters.
